(19) United States
(12) Patent Application Publication
(10) Pub. No.: US 2012/0219938 A1
(43) Pub. Date: Aug. 30, 2012

(54) Process for Analyzing Effectiveness of a Course of Study

(76) Inventor: Zaid N. Al-Shammari, Waha (KW)

(21) Appl. No.: 13/034,274

(22) Filed: Feb. 24, 2011

(51) Int. Cl. G09B 19/00

(52) U.S. Cl. 434/322

(57) ABSTRACT

A method for analyzing the student's performance in a course for an individual student and/or for a group of students' to identify a plurality of learning objectives, designing a plurality of course requirements and determining student's achievement. The learning objectives, course requirements and student achievements are then combined and may be compared with prior or subsequent courses. During this analysis the learning objectives are identified based on knowledge and skills that a student will gain as achievements, while the performance of the student based on students achievements are measured and calculated

### FIELD OF THE INVENTION

This invention relates to a method for analysis performed on the pre-defined learning objectives based on the actual performance of student's achievements to derive the true Learning Outcomes.

### BACKGROUND FOR THE INVENTION

Methods for tracking the progress of students in a class, for evaluating the performance of an instructor and for monitoring a computer assisted performance assisted support to correct workers deficiencies are known. For example, U.S. patent of Ciarallo et al., U.S. Pat. No. 6,704,541 describes a method and system for tracking the progress of one or more students in a distance learning environment. The system includes a school computer and one or more student computers. A course site including course graphics representative of course activities and progress graphics representative of individual students' progress in performing the course activities, allows school officials and/or students to track and compare their progress to those of other students in the class.

Using this method, supervisors can gauge the past and present comparison, however, the use of course requirements and learning objectives are absent in this system. The Ciarallo et al. system is designed for a distance learning environment wherein the use of remote computer and network connectivity is a requirement. Also, the system is University owned wherein the course activities allow school officials and/or students to track and compare their progress to those of other students' in the class. The method in accordance with the present invention needs a computer and internet connection only after the results of students have been published in hard or soft formats to be entered into the online system. This access is only to supervisors, teachers, faculty or teaching staff and not to students.

A method and system for evaluating the performance of an instructor of an electronic course is disclosed in a U.S. patent of Woodson, U.S. Pat. No. 6,789,047. As disclosed the method and system is suitable establishing a performance based component of pay for the instructor and to provide the instructor with a financial incentive for meeting a performance goal. A communications monitor monitors quantitative performance data on the instructor and students participating in an electronic course. A first data base stores the monitored quantitative performance data. A data processor determines at least one quantitative evaluative factor of a course attendance factor and an instructor's response time based on the quantitative performance data. The communications monitor facilitates the gathering of qualitative performance data in a second database. The quantitative performance data may be reviewed to form a qualitative evaluation report of the instructor.

The Woodson method and system is primary based on evaluating an instructor's performance and not student performance. Although, the student performance like activities or events of students, students participation time and student to student or student to instructor interaction is accounted for, the benefit that is received for the compliance and the best behavior or performance is focused towards the instructor rather than the student. By contrast, the present invention focuses more toward the students' performance and brings out the problem areas of the student, the expectations from the student and to find out whether the instructor's course objectives were met.

Finally, a U.S. patent of Ryan et al., U.S. Pat. No. 6,871,195 discloses a method and system for remote electronic monitoring and mentoring of computer assisted performance support. As disclosed the system includes remote electronic monitoring and mentoring to provide supervision, control and instruction of the worker while the worker performs directed tasks. Activity data representative of worker activities are collected at the work site and can be accessed by a remote supervisor. The remote supervisor generates and transmits to the worker feedback based on the activity data. The remote supervisor can evaluate an activity trial of a worker's performance of directed tasks and development of skills through educational training to permit timely identification and correction of worker deficiencies. The ability of the remote supervisor to transmit feedback to the worker while the worker is performing directed tasks enhances rapid development of the worker skills and work place safety and productivity.

The Ryan et al. method and system is based on an outline remote monitoring tool that leads a worker and provides the worker with an on the job supervision and mentoring which provides accelerated learning of repetitive, complex and structured tasks to become more skilled and proficient. However, the present system is not an online activity guiding a student or learner, but a tool to analyze the pre-performed activities of the student and then measured whether the students' achievements meet the learning objectives.

The present application discloses a tool that provides an effective way to analyze students' performance based on certain course requirements and pre-defined learning objectives built on a strategy while using students' achievements data. The end result, known as Learning Outcomes, is provided by the present invention.

### BRIEF SUMMARY OF THE INVENTION

A method for analyzing the student's performance in a course for an individual student and/or for a group of students includes the following steps:

Identifying a plurality of learning objectives for an individual course as for example a course in advanced education; and

Designing a plurality of course requirements for the individual course.

The method also includes the step of determining student achievements for a plurality of individual students combining the learning objectives, course requirements and student achievements to produce learning outcomes for a plurality of individual students. Finally, the method includes the step of extracting individual learning outcomes and finalizing overall learning outcomes to thereby assess the effectiveness of students' performance according to the learning objectives.

The invention will now be described in connection with the following figures wherein like reference numerals have been used to indicate like parts.

### DESCRIPTION OF THE DRAWINGS

FIG. 1 is a schematic illustration of a flow chart that illustrates the logic for a method for analyzing the effectiveness of a course of study;

FIG. 2 is a graphical illustration of results of analyzing learning outcomes in three different education courses as obtained by the method in accordance with the present invention;

FIG. 3 illustrates a log in page for a program in accordance with the present invention;

FIG. 4 illustrates a main menu for using an analysis method for learning objectives;

FIG. 5 illustrates a worksheet for inputting information on the instructor of a course;

FIG. 6 illustrates the inputs for the course requirements;

FIG. 7 illustrates an input for course requirements for a given course;

FIG. 8 illustrates an input sheet for analyzing the results from a course;

FIG. 9 illustrates an input sheet for the results from a plurality of courses;

FIG. 10 illustrates an information sheet illustrating historic information;

FIG. 11 is an example of a student information sheet for the entry of student information;

FIG. 12 illustrates an entry for course objectives;

FIG. 13 illustrates an entry sheet for course requirement related objectives;

FIG. 14 illustrates a course requirements, objectives and student's score information; and

FIG. 15 illustrates a requirement score sheet.

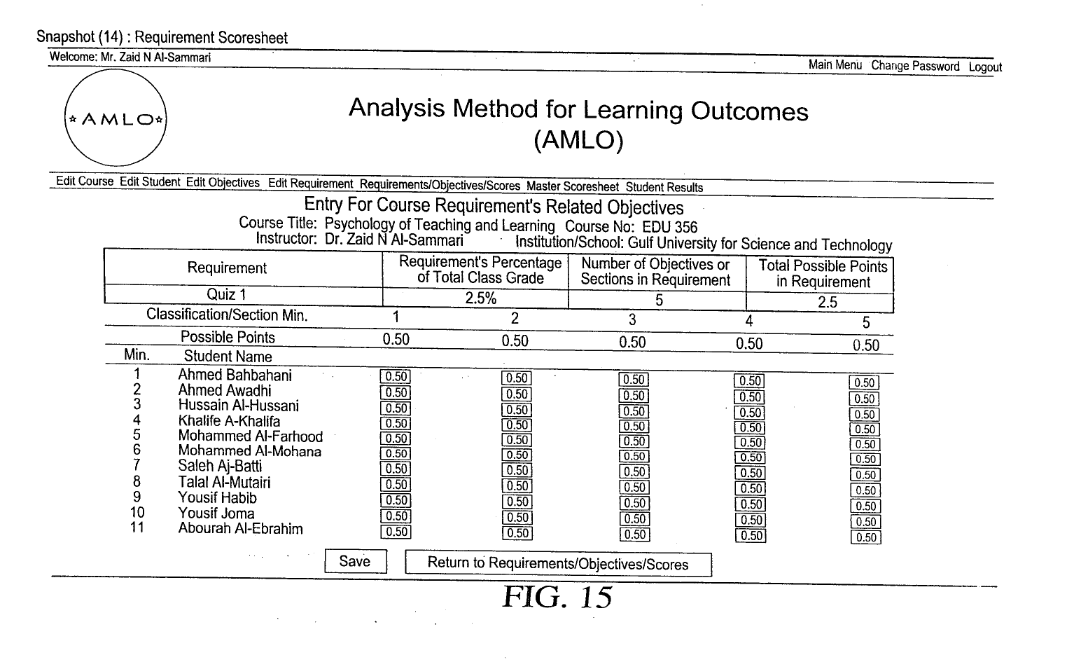

### DESCRIPTION OF THE PREFERRED EMBODIMENTS OF THE INVENTION

An Analysis Method for Learning Outcomes (AMLO) is designed to analyze Students Achievements through Course requirements and Learning Objectives to derive Learning Outcomes for courses of study. AMLO has been developed to benefit all faculty, instructors, researchers, and professionals interested in analyzing student achievement and achieving learning objectives in academic courses that helps them in modifying and improving curriculums and overall outcomes in individual courses, programs, for higher educational institutions.

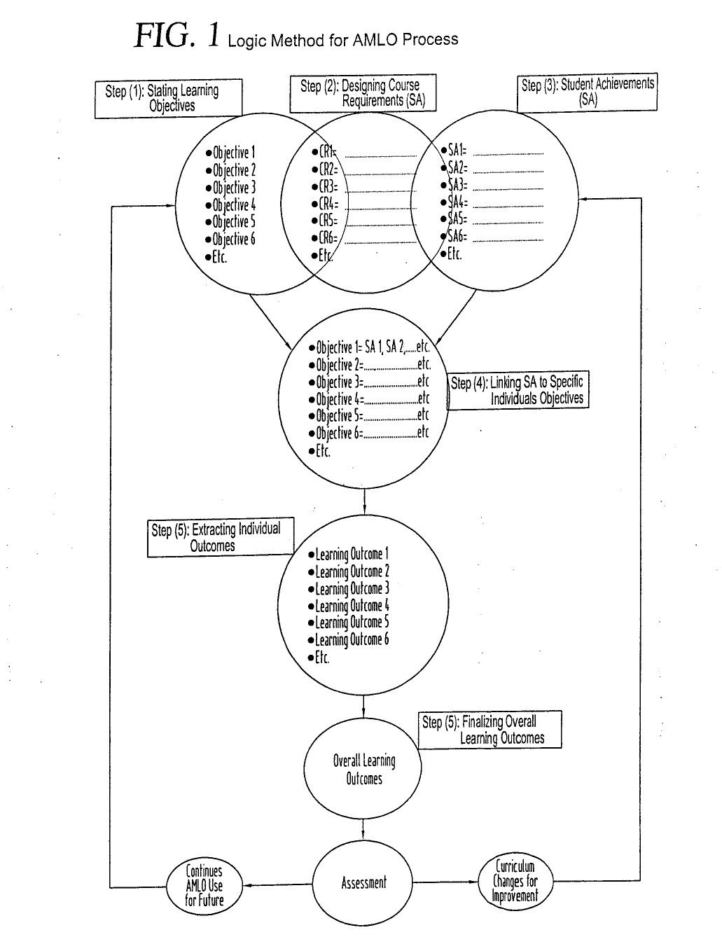

Through an analysis of learning objectives, course requirements and student achievement (from assignments, quizzes, exams, presentations and projects), the important learning outcomes can be realized as shown in a logic model as shown in FIG. 1. In addition, there are several steps (as shown in the figures) as well as listed and described within this Specification to provide what the individual instructors or users should do when using an Analysis Process for Learning Outcomes.

### Analysis Process for Learning Outcomes

An Analysis Method for Learning Outcomes that practically constructs a process which helps professional educators looking for the learning outcomes and specific percentages of achieving learning objectives in their academic program.

The process depends on several variables that individual instructors can use for analyzing results of student achievements. If for example an instructor is looking for intentional learning outcomes, the instructor needs to assess results of course assessments. This analysis process provides instructors who are looking for a professional but easier method to analyze student achievement-based outcomes measured by several assessment types during a program or course of study in higher education institutions.

The process aims at providing professional analysis for learning outcomes primarily in the field of education with the following benefits:
Percentages of Achievement
Percentages of achieving Learning Objectives individually and in an overall assessment for each course of study in a program
Indicators of strength and weaknesses based on learning outcomes for improvements in future teaching
Information, statements and graphs for course and learning outcomes

To extract the Learning Outcomes for any academic course, instructors need to analyze three variables:
1. Students Achievements
2. Learning Objectives
3. Course Requirements

### Resources

This section is divided into four subsections: (1) Learning Objectives, (2) Learning Outcomes, (3) Students Achievements, and (4) Course Requirements. This provides information about the most important variables needed for processing an analysis model through the steps and procedures offered for individual educators.

### (1) Learning Objectives

Learning objectives are generally those specified actions which can be observed, measured and performed by the learners. It is an objective that is pre planned describing what students should be able to do at the end of a course. Learning Objectives are mainly about what students are able to do in learning activities which mostly focuses on the Student Performance e.g. (1) Identify basic concepts, knowledge and skills needed by the professional educator, and (2) Use effective communication techniques with all students, parents, and school administrators and staff.

Instructors should always start with identifying the knowledge and skills that students will gain at the end of the course of study. This helps an instructor to define and make their own decision, strategy, and create their own course learning objectives.

The characteristics of Learning Objectives should reflect broad conceptual knowledge and adaptive vocational and generic skills, essential knowledge, skills or attitudes, focus on results of the learning experiences, reflect on the desired end of the learning experience, not the means or the process, represent the minimum performances that must be achieved to successfully complete a course or answer the question, “Why should a student take this course?”

Learning objectives should be measurable, which will show that the student has achieved the learning objectives through the course requirements such as written exams, orals, individual and team projects, or other requirements. Students should know what is expected of them in order to perform successfully.

### (2) Course Requirements

In academic courses, there are certain course requirements that determine the gained knowledge and skills which are measured through several types of traditional and authentic assessments such as Examinations, Quizzes, Presentations, Projects, Assignments, etc.

### (3) Students Achievements

Students Achievements is an indication of gained knowledge and skills that are measured by different types of course requirements. The results of the course requirements are graded by the instructor, which provides an insight of the students learning capability, expression, dedication and knowledge of the area that was put to assessment. The most important thing in calculating students' achievements is the measuring tool by which a student can be judged. These tools can be in a calculated formula or faculty's assumption of intellectuality. The below is an example in a tabulated manner for three different levels of courses taught at Gulf University.

TABLE 1
Learning Outcomes for EDU 452
Course Title: Instructional Materials Development
Instructor: Dr. Zaid Al-Shammari
Course No: EDU452
Institute/School: GUST

| | | | Questions/ | Learning |
|---|---|---|---|---|
| | | | Sections | Outcome |
| Student | | Total | Related to | Percent- |
| No. | Objectives | Students | Objective | ages |
| 1 | Demonstrate an | 6 | 7 | 93.90 |
| | understanding of the | | | |
| | instructional material | | | |
| | development process | | | |
| 2 | Identify and summarize the | 6 | 9 | 92.49 |
| | major elements commonly | | | |
| | included in instructional | | | |
| | materials development and | | | |
| | models through experience | | | |
| | in their own instructional | | | |
| | project | | | |
| 3 | Define terms used in the | 6 | 2 | 67.19 |
| | instructional materials | | | |
| | development process | | | |
| | through successful | | | |
| | completion of end of | | | |
| | chapter practices and | | | |
| | optional quizzes | | | |
| 4 | Demonstrate the following | 6 | 9 | 83.79 |
| | competencies in the | | | |
| | completion of an | | | |
| | instructional project: | | | |
| | Identify an instructional | | | |
| | problem (a topic from | | | |
| | curriculum) | | | |
| 5 | Demonstrate the following | 6 | 7 | 84.31 |
| | competencies in the | | | |
| | completion of an | | | |
| | instructional project: | | | |
| | Plan, design and implement | | | |
| | instructional needs and | | | |
| | materials | | | |
| 6 | Demonstrate the following | 6 | 1 | 87.50 |
| | competencies in the | | | |
| | completion of an | | | |
| | instructional project: | | | |
| | Select and develop | | | |
| | appropriate instructional | | | |
| | materials and strategies | | | |
| Total | | 6 | 35 | 84.48 |

TABLE 2
Learning Outcomes for EDU 454
Course Title: Classroom Management
Instructor: Dr. Zaid Al-Shammari
Course No: EDU454
Institute/School: GUST

| | | | Questions/ | Learning |
|---|---|---|---|---|
| | | | Sections | Outcome |
| Student | | Total | Related to | Percent- |
| No. | Objectives | Students | Objective | ages |
| 1 | Demonstrate understanding | 5 | 7 | 65.34 |
| | of classroom management, | | | |
| | skills, concepts and | | | |
| | techniques | | | |
| 2 | Apply classroom | 5 | 7 | 66.27 |
| | management skills, | | | |
| | concepts, and | | | |
| | techniques in teaching | | | |
| 3 | Demonstrate understanding | 5 | 4 | 64.09 |
| | of designing and using | | | |
| | classroom rules and | | | |
| | procedures | | | |
| 4 | Effectively mange and | 5 | 5 | 71.60 |
| | discuss the student | | | |
| | work assignments and | | | |
| | requirements | | | |
| 5 | Develop understanding | 5 | 4 | 73.22 |
| | in planning and | | | |
| | conducting instruction | | | |
| | and materials | | | |
| Total | | 5 | 27 | 67.33 |

TABLE 3
Learning Outcomes for EDU 355
Course Title: Instructional Methods
Instructor: Dr. Zaid Al-Shammari
Course No: EDU355
Institute/School: GUST

| | | | Questions/ | Learning |
|---|---|---|---|---|
| | | | Sections | Outcome |
| Student | | Total | Related to | Percent- |
| No. | Objectives | Students | Objective | ages |
| 1 | Understand central | 2 | 4 | 89.82 |
| | concepts and methods | | | |
| | of teaching that | | | |
| | create meaningful | | | |
| | learning experiences | | | |
| 2 | Understand how students | 2 | 8 | 89.92 |
| | differ, learn, and | | | |
| | develop to providing | | | |
| | effective instructional | | | |
| | opportunities that | | | |
| | support their | | | |
| | intellectual, social, | | | |
| | and personal development | | | |
| Total | | 2 | 12 | 89.89 |

Learning Outcomes are final reports of summative evaluation that indicate what learners achieved as a result of a learning activity and experiences in a course or program of study. The learning outcomes install a framework outlining and guiding the direction of improvements in the learning activity or experiences. The process helps to:
Highlight on learner's current performance and the need to change.
Serve as guidelines for content, instruction, and assessment and curriculum changes.
Recognize particularly what has been achieved and what is needed for improvements for future learning of the same materials.
Convey to learners exactly what is to be accomplished.

Analyzed data related to Learning Outcomes determines the quality of a course, program and an institution. This in turn also helps to collect proof of Student's Academic Achievement and effectiveness of teaching practices through achieving learning objectives assigned for any course of study. There are several parties like government and non-government, educational councils, stakeholders and public who want to see the reports of such learning outcomes. Such results help educational institutions and/or individuals to make their own strategies and decisions about future learning and educational improvements.

The process disclosed herein is designed to provide the teacher with an analysis method that measures the effectiveness and achievement of Learning Outcomes based on the learning objectives, student achievement, and course requirements in academic courses.

As with any process that relies on user input, the integrity of the results will be directly affected by the quality of the data the instructor enters. The more accurate and complete the data the instructor enters, the more accurate the analysis and its results. The process is very intuitive, and the user should be able to work his way through the input process with little difficulty. The following five guides are designed to help instructors (users) through any difficult parts.

### (1) Login Page

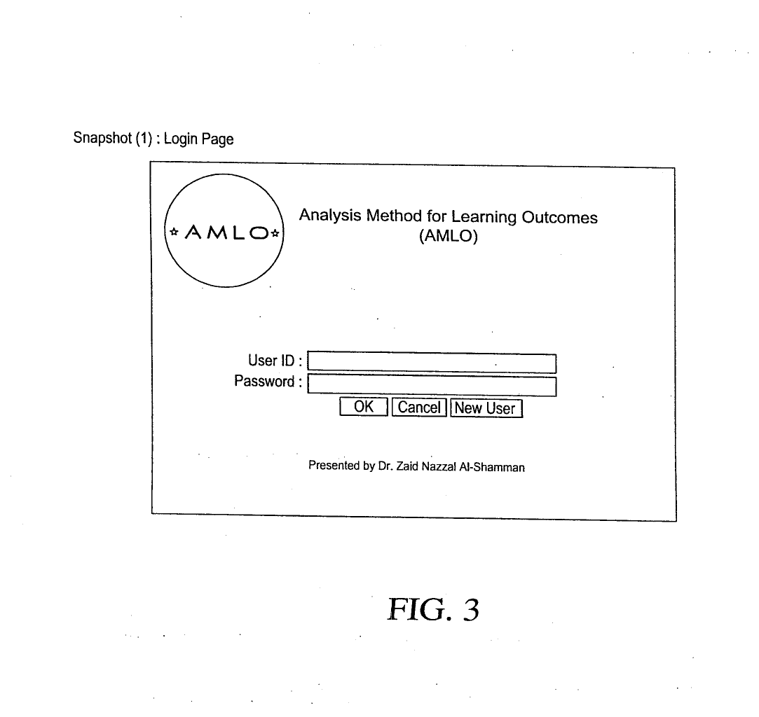

This is where the instructor enters data. It requires a Username and Password. These are chosen by the instructor when he/she does the initial registration. After the instructor accesses the Login Page, enters his/her Username and Password in the spaces provided and hits “Enter” or clicks “OK” or “Cancel” to cancel his/her Login attempt. For further information on what and/or how to use this login page, FIG. 3 shows an example of data entered by a user.

### (2) Main Menu

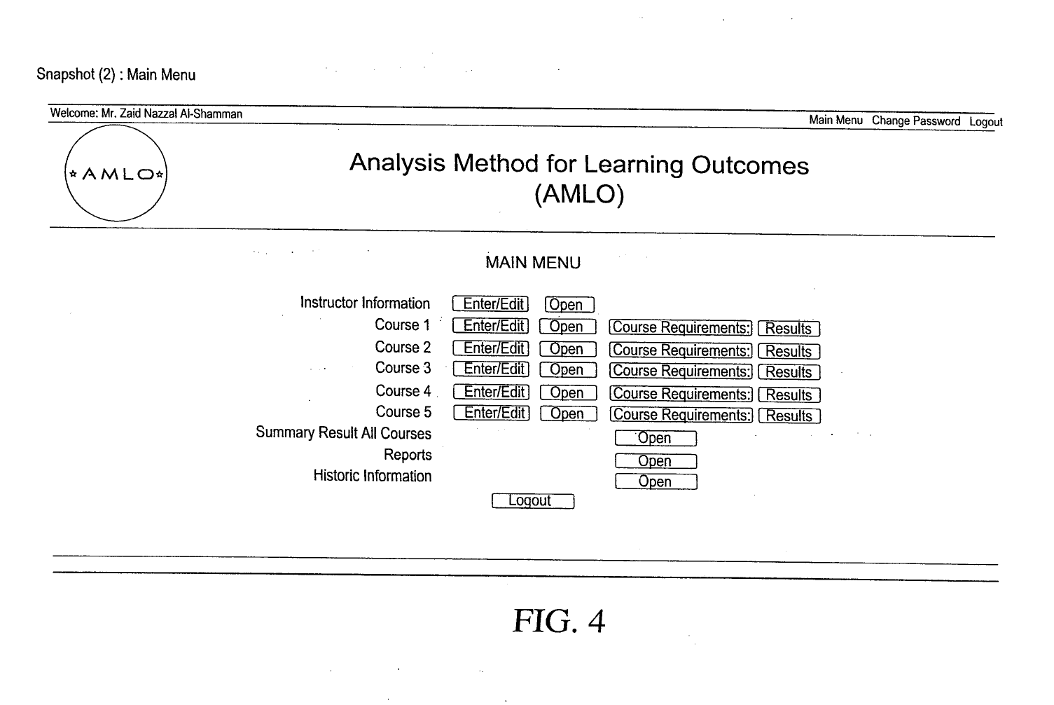

The Main Menu, as shown in FIG. 4, is the main navigation page for the instructor's use of the process. It allows the users to access the various features and to the information the instructor has entered. It also provides users access to the results of their “Learning Outcomes” Analysis. The Main Menu items include the following:

### Instructor Information:

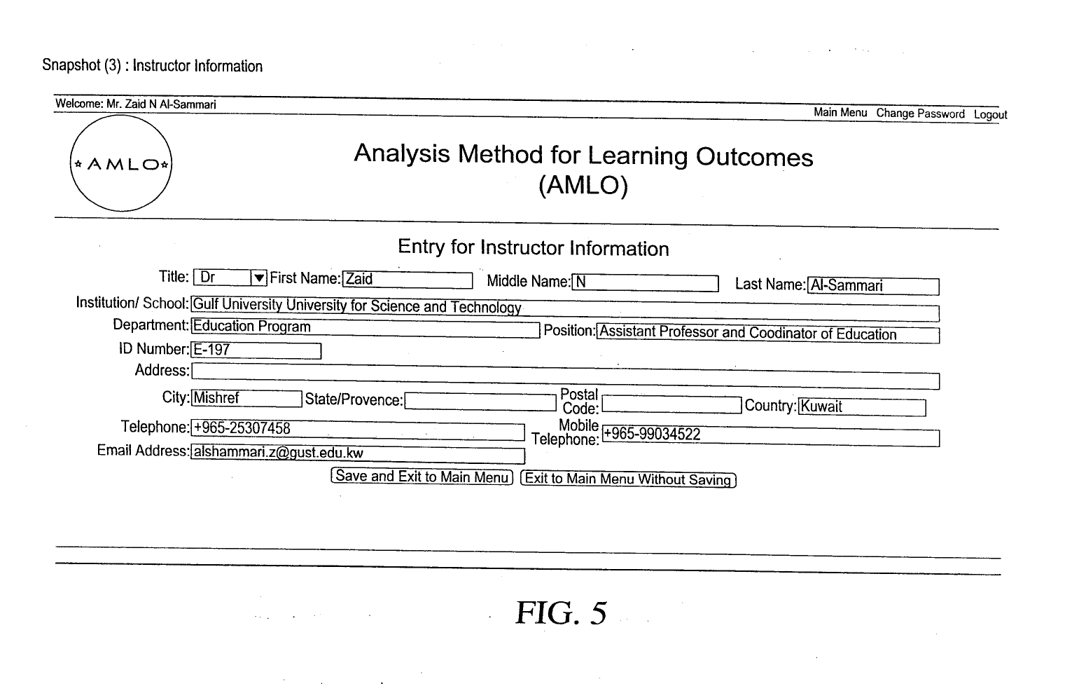

This is information about the instructor as shown in FIG. 5. It is essentially the same information the instructor entered when he/she registered for access to the process. There is an “Enter/Edit” page that allows the instructor to make changes and keep this information up to date, or the instructor may simply click OPEN to view the information.

### Courses 1 Through 5:

This is the data and information for up to 5 courses that individual users teach in each academic semester.

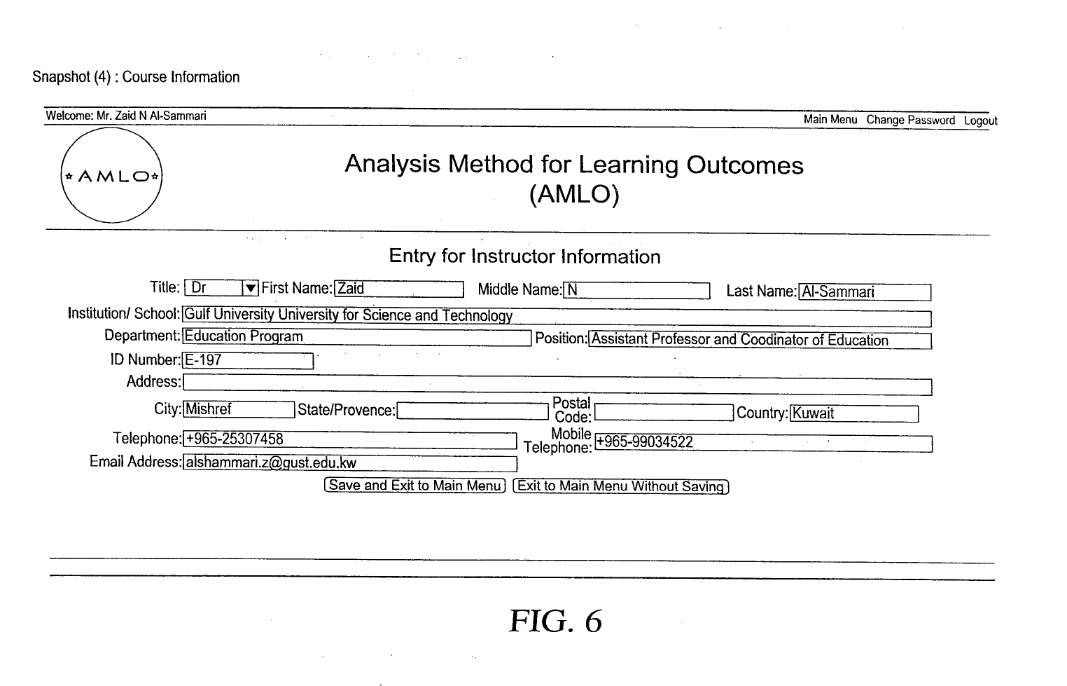

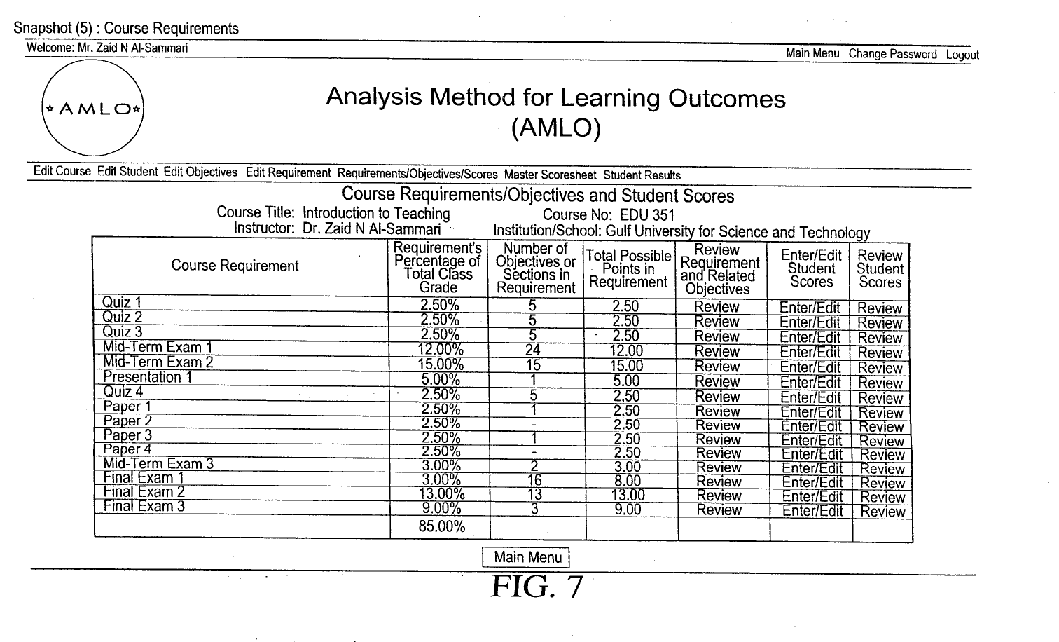

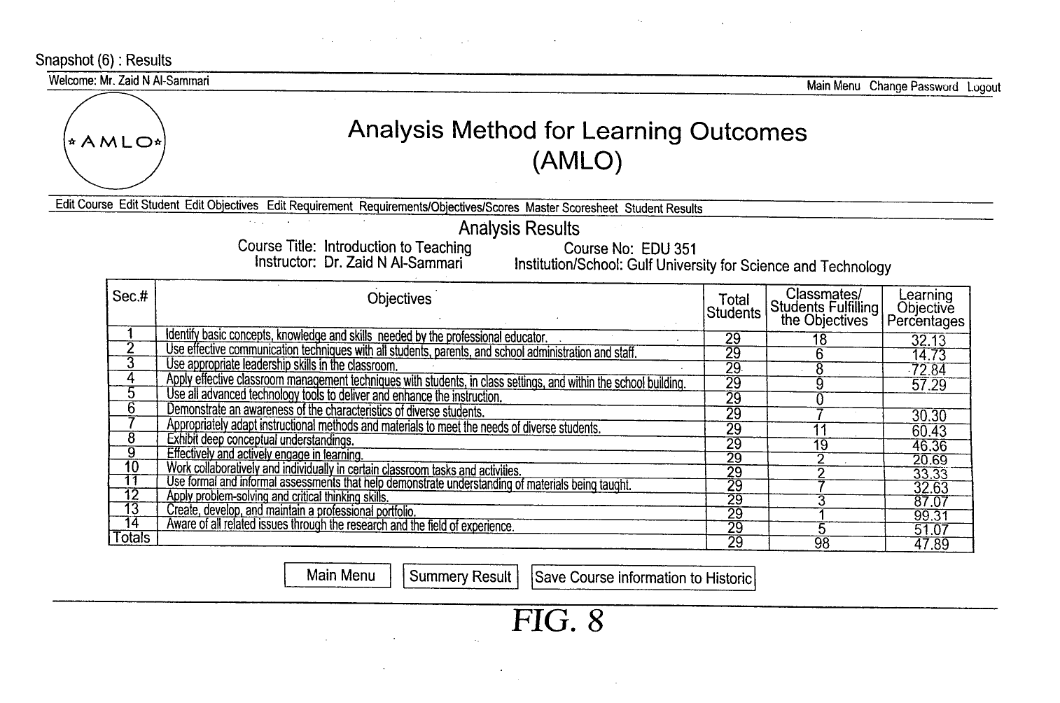

1. The “Entry/Edit” button allows the user access to the pages where information regarding their Courses, Students, Course Requirements and Objectives and Student Scores is entered and compiled. See the example in FIG. 6 in which provides a clearer idea on using this selection button.
2. An “Open” button provides the user access to static pages of saved information. This is because users do not have to deal with the entry pages once the data has already been entered.
3. The “Course Requirements” button, as shown in FIG. 7, is a shortcut option that takes users directly to where they need to enter the critical student scores.
4. The “Results” button, as shown in FIG. 8, also takes users directly to a quantitative analysis of the Learning Outcomes he/she is trying to achieve and extract by the end of the academic semester.

### Summary Results All Courses:

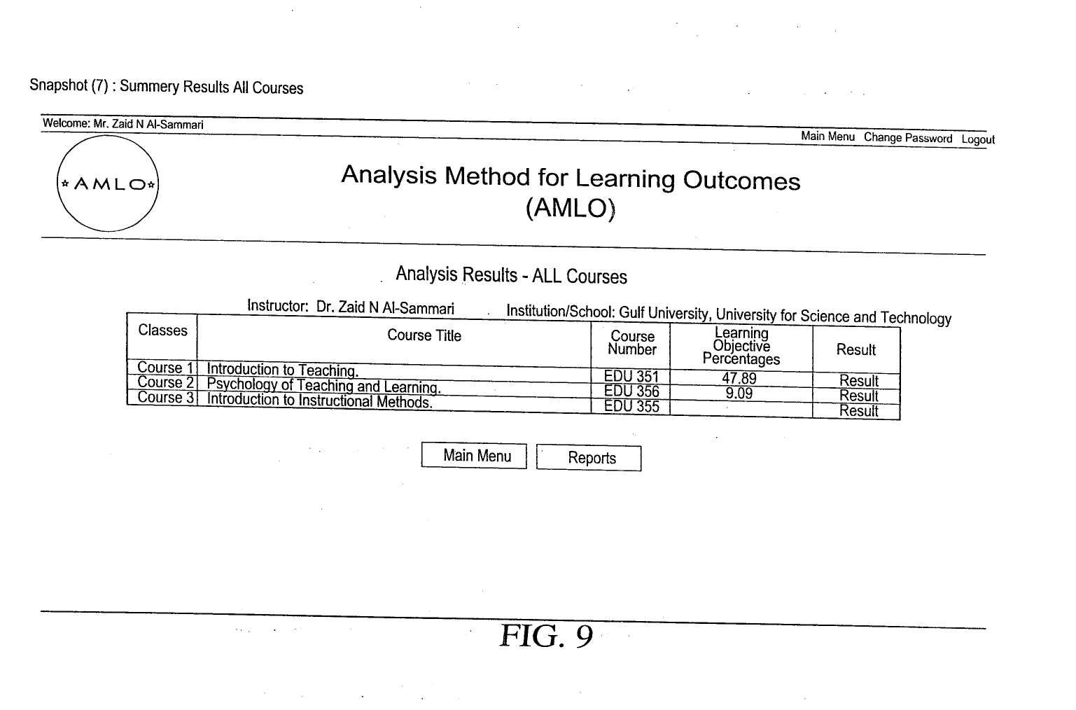

This is a summary page giving all courses and a course overview of the Learning Outcomes Analysis. FIG. 9 provides an example of how this looks.

Reports: The data entered and the information produced, including the Learning Outcomes extracted is available to be viewed on screen, or printed as “hard copy” from the Reports button.

### Historical Information:

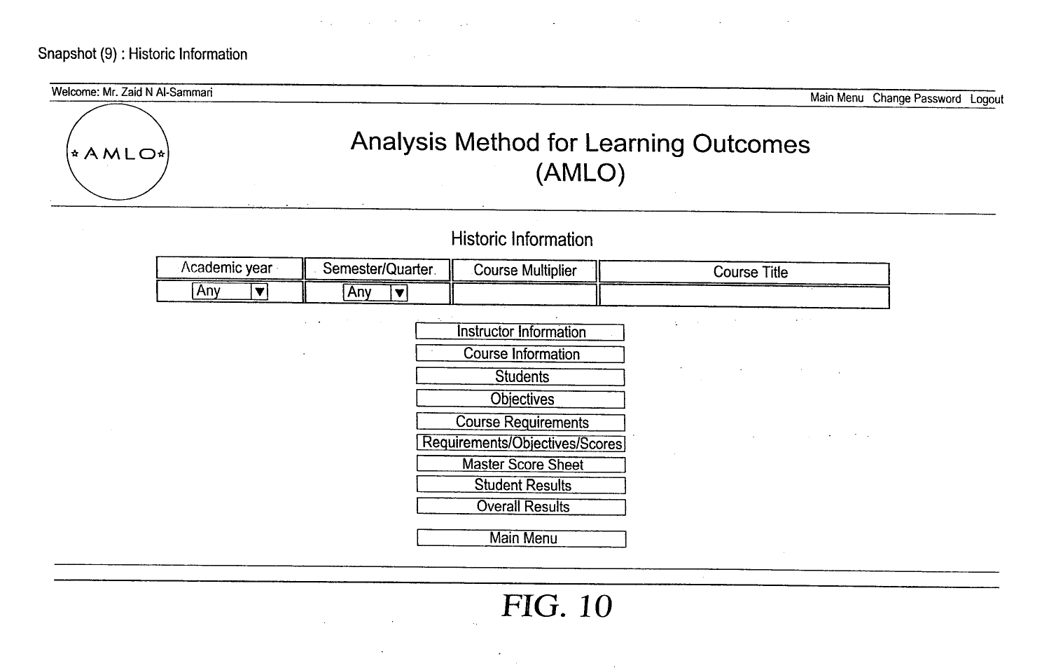

All Course data and information may, at the instructor's option, be stored historically. Users may access this information as long as he/she remains an active user. The Main Menu is available from any page by simply clicking on the “Main Menu” located in the upper right-hand corner of each page. FIG. 10 provides users with how this page looks.

### (3) How to Get Started?

There is a step by step process that makes it simple and intuitive. The instructor should follow these simple steps from the Main Menu.

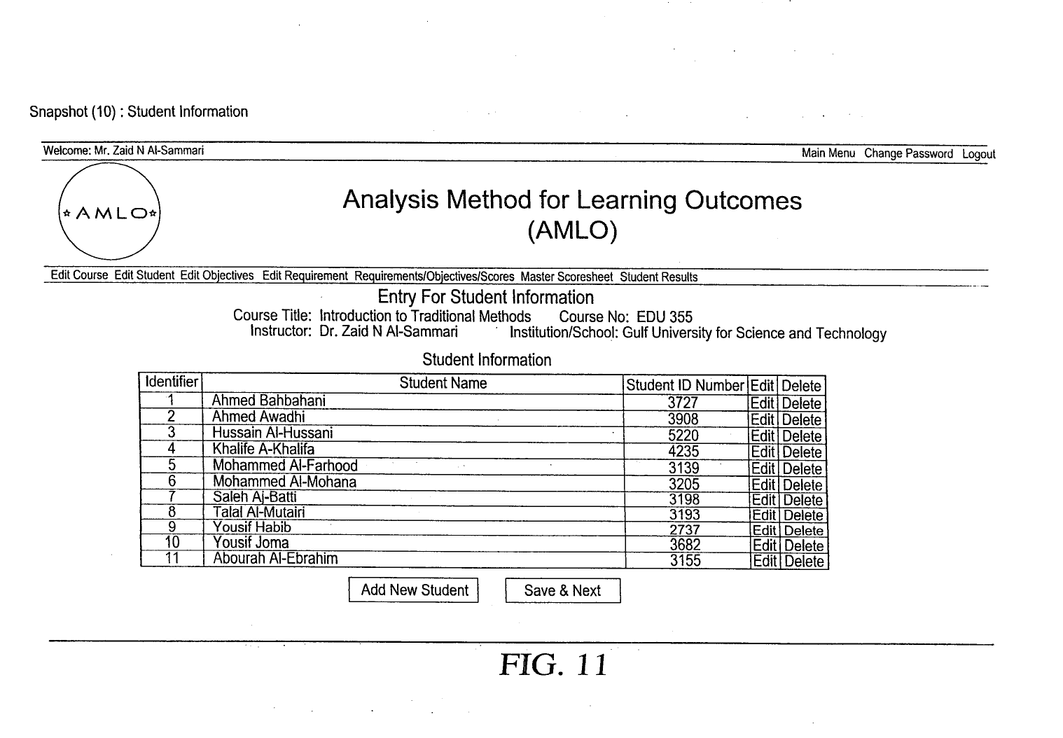

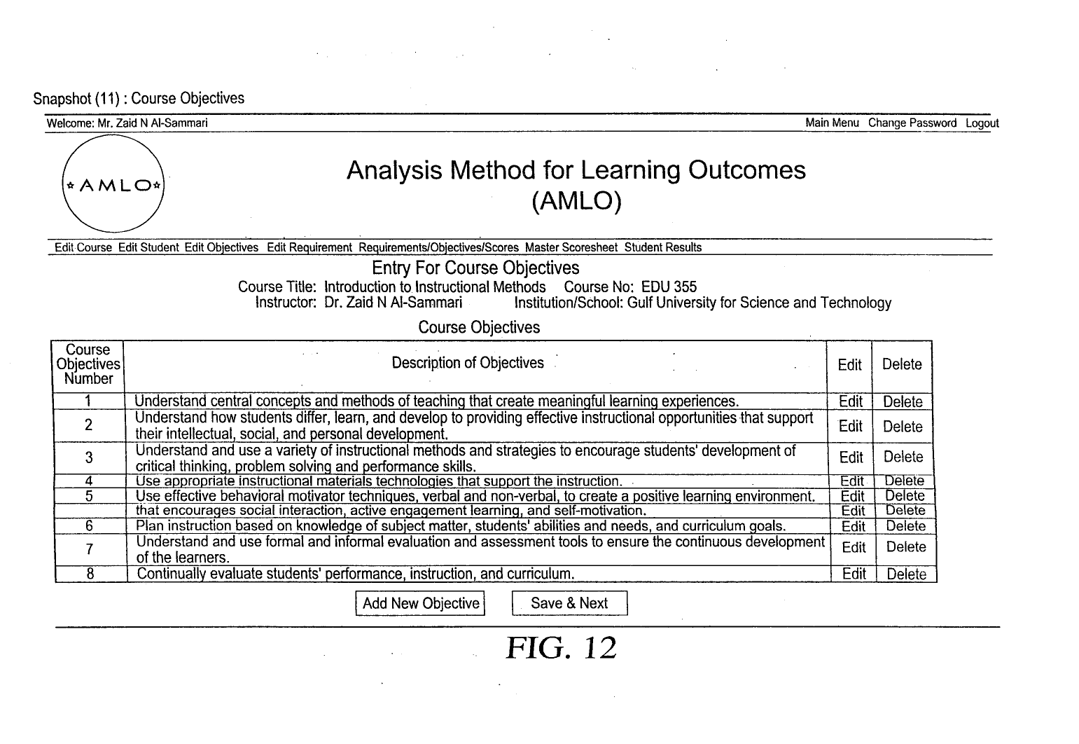

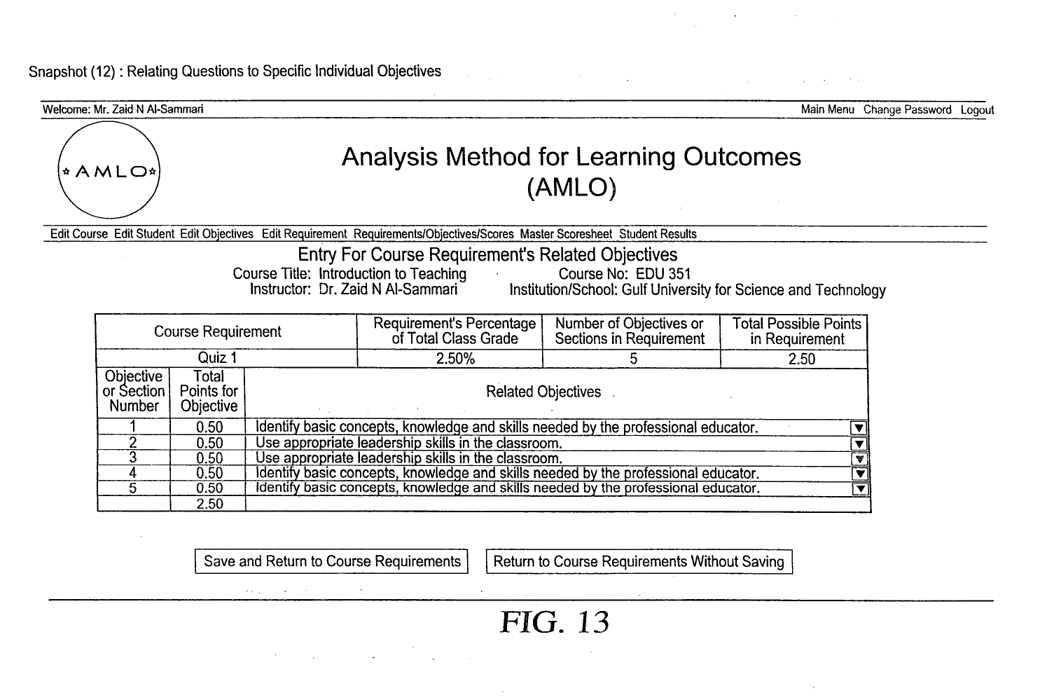

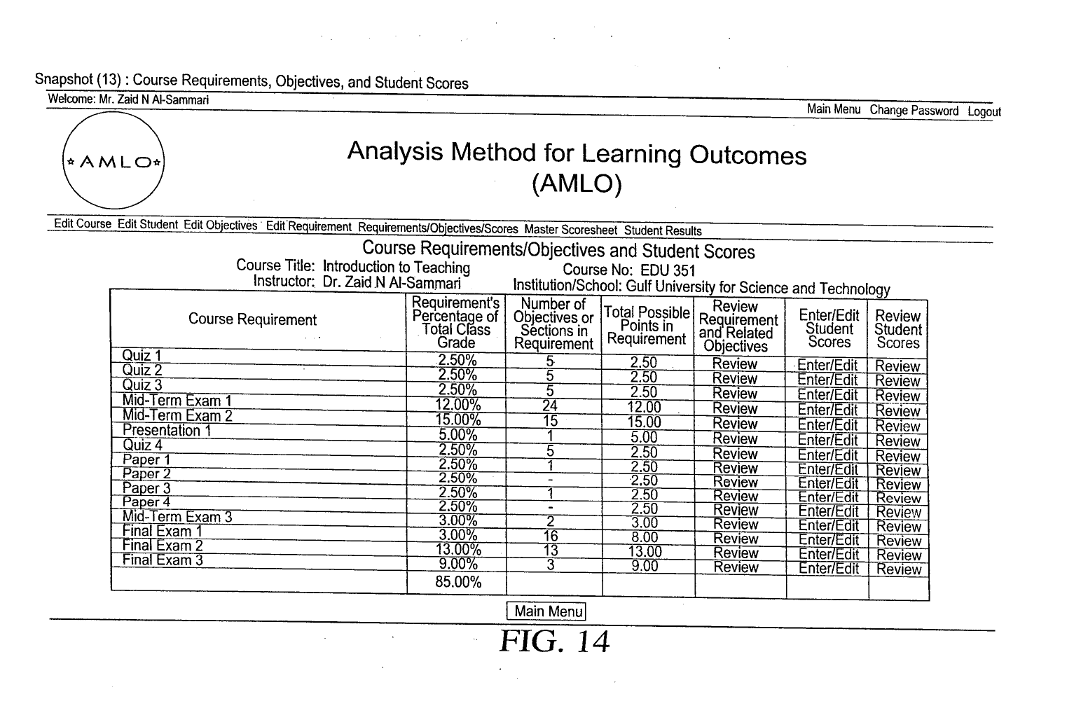

1. The instructor should first check the “Information”. The first step is to take a quick look at the Instructor Information and make sure it's complete and accurate. Once the instructor does that, he/she goes back to the Main Menu. FIG. 4 also provides a picture of what information needed in this page.
2. Under the heading for “Course 1”, hit the button titled “Enter/Edit”. Clicking this button will take the instructor to a page titled “for Course Information” This page, as shown in FIG. 6, identifies the Course the instructor wants to analyze. It's important to complete as much as possible. Therefore, the instructor must fill in all the blanks. Please note that the starting and ending dates have drop down boxes to help the instructor with entering the correct dates. When the instructor has it all filled out, hit the button at the bottom for “Save and Enter Next”. This will take the instructor to the next entry page, which is information about his/her students.
3. The “for Student Information” page lets the instructor enter the names of his/her students. Users should enter these names in the same order as their grade records will appear as shown in FIG. 11. This will make it much easier to enter the student scores that will be required later. There is a space for the student's name, and also for the student number or other identifier that the instructor may use to differentiate one student from another. Please note that the instructor may enter two students with the same name, but each number must be unique to the student. To add a new student, simply click on the button “Add New Student”, enter the name and number in the boxes provided and hit “Save”. Repeat the process for each additional student. Please note that the instructor can modify a student's information by simply clicking the student's name. Make the changes, then “Save”, just like entering a new student. The instructor can also delete a student at any time. However, please be cautious. Once Student Scores have been entered, deleting a student will change all the related pages, and the deleted student's information will be permanently lost. When the instructor has completed the entry of Student Names, he/she should simply click “Save & Next” to proceed to the next entry page.
4. The instructor now reaches the page “for Course Objectives”. This page, as shown in FIG. 12, is where the user enter the Course Objectives he/she hopes to achieve by the end of the academic semester. To enter a Course Objective, simply click the button title “Add New Objective”, fill in the provided box, and hit “Save”. The instructor should make sure that Objectives are as accurate and complete as possible, because once the he/she starts entering Student Scores, he/she will not be able to delete any of the Objectives entered. Editing, however, may be done at any time by simply clicking on the Objective name. When the instructor has completed entering his/her Course Objectives, click on “Save & Next” and proceed to the next page.
5. The “for Course Requirements page allows the instructor to identify the ways the instructor will measure the student's understanding of the Course Objectives. These measurements as the Course Requirements as shown as an example provided by FIG. 7. The list of possible requirements is in a drop-down box and includes: Quiz, Mid-Term Exam, Final Exam, Presentation, Papers, Assignment, Projects, and Others. On the Entry for Course Requirements Page the instructor simply lists the Course Requirements he/she plans on using for this particular Course. The instructor will need to know the following information: regarding each requirement:
The Course Requirement's relative contribution towards the total grade, expressed as a percentage
The total number of questions or sections included in the Course Requirement. A “Quiz”, for example may have 10 questions. A “Paper” may have only one section.
The highest total number of points possible to be achieved for the Course Requirement, and the number of points allocated to each question of the Course Requirement
To add a new Course Requirement, click the button for “Add New Course Requirement”, enter the information, and then click “Save”. Repeat the process for each new Course Requirement
   6. The next step asks users to relate a Course Objective to each separate question of the individual Course Requirements as shown in FIG. 13. As the instructor finishes entering the Course Requirements, he/she will see a column titled “Enter Related Objectives”, simply click on this label for each Course Requirement, and it will take the instructor to an entry page titles “for Course Requirements Related Objectives and student scores as appear in FIG. 14. There is a separate page for each Course Requirement. At the top of the page the instructor will see a summary of the Course Requirements, including the total possible points and the total number of questions or sections. The left hand side of the page lists the questions, one by one, and gives the instructor a space to fill in the number of points allocated to that particular question. Next to it is a drop down box allowing the instructor to choose that particular Course Objective that most closely relates to that question or section of the Course Requirement. Unfortunately, the instructor can only choose one Objective for each question/section, therefore, if the instructor has a paper that relates to multiple Objectives, simply break it into sections and relate a different Objective to each section. The instructor has to be accurate with his/her numbers. The process will not let the instructor enter points for the individual questions/sections that does not equal the total listed. When the instructor finishes allocating points and relating Objectives, simply click the “Save and Return to Course Requirements” button. Then follow the same procedure for the next Course Requirement until the instructor has done them all. The instructor has now provided most of the essential data needed to do its analysis work. Click on “Save & Next” and go to the next screen.
   7. The “Requirements/Objectives” and “Student Scores” page as shown in FIG. 14 becomes his/her focal point from this point forward. From this page users can review each Course Requirement and its related Course Objective. This page also acts as the portal for the entry of Student Scores. The instructor may access this page directly from the main menu by clicking on the “Course Requirements” button. Once a Course Requirement has been completed and graded, the Student Scores need to be entered. Each Course Requirement has a separate entry page. Click the tab in the column titled “Enter/Edit Student Scores” and it will take the instructor to the entry page for that particular Course Requirement.
   8. The “Scoresheet” shows each student's name as an example provided in FIG. 14. Opposite their name is a series of entry field corresponding to each questions/section of the Course Requirement. Simply fill in that student's scores, expressed in points, on each question/section in the appropriate entry field. Please note that the instructor will not be allowed to enter a score higher than the total possible points for that question. Once all the scores have been entered, click “Save”. Then click “Return to Requirements/Objectives/Scores” to go back to the main page. Repeat this process after each Course Requirement has been completed and graded. In the Menu strip just below a Heading, there is a selection for “Master Scoresheet”. The Master Scoresheet is a single page document that lists all the Students and their scores on all of the Course Requirements. The instructor can use this sheet as a master reference as to what has been entered with regards to Student Scores.

### (4) Adding One Course

To add another Course simply go back to the Main Menu and click on Enter/Edit next to the heading “Course 2”. The instructor may repeat to track up to 5 courses simultaneously.

### (5) Other Information

Here is some general information that may be helpful. In the same Menu strip below the Heading, there is a selection for “Results”. A similar button is on the Main Menu. This page details the analysis results. Be cautious, however, since the results shown will not be accurate till all Student Scores from all Course Requirements have been entered.

The “Results” page also allows the instructor to save the all the Course Information and results into a Historic file. Be extremely cautious, however, because once saved into the Historic files, no changes can be made to the information. If the instructor is using the process disclosed here for the analysis of more than one Course, the instructor may also want to look at the “Summary Results”. This page may be accessed through a button at the bottom of the “Results” page, or from the Main Menu. This page summarizes the results of all of the instructor's listed Courses.

From the Main Menu the instructor can also access the “Reports” page. A multi-level selection process allows the instructor to print information from all his/her listed Courses. Also, the “Historic” section allows the instructor access to information on past Courses that were tracked. Information is available either to view or to print.

### Data and Results

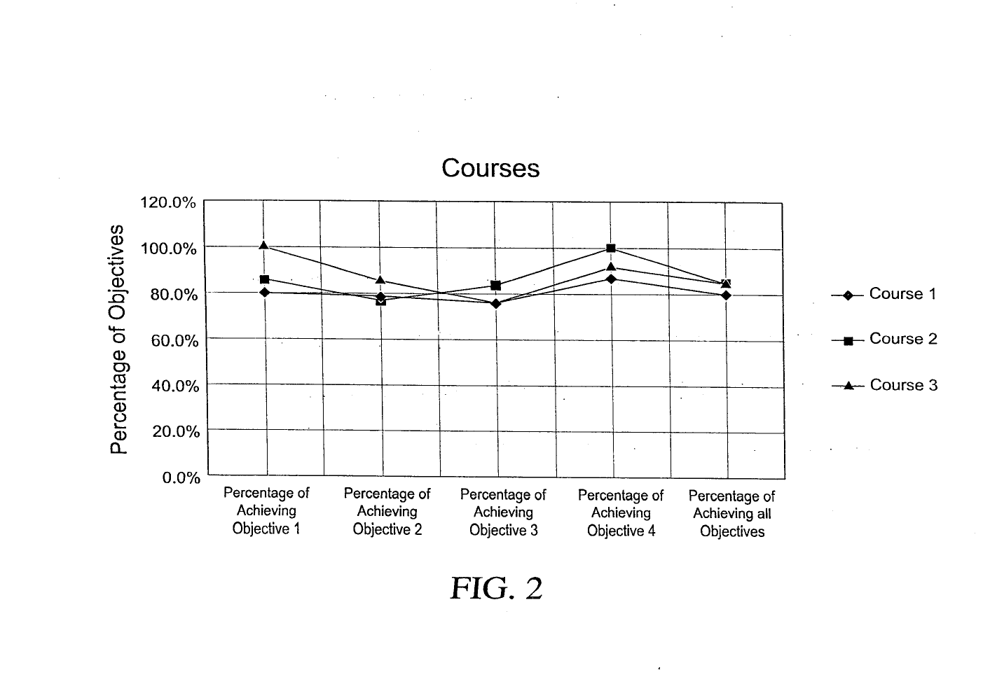

The Graph in FIG. 2 shows the achievement percentages of the learning Objectives for three courses selected for the analysis purposes. The achievement percentages of the objectives are varied as per the number of Objectives set in each of courses. Each achievement percentage is calculated, delivering the exact level of achieving each and overall objectives set by the instructor.

This graph is a demo of the percentage achieved by students for each objective in each of the three courses. Each of the courses has a specific value and figures. Those figures were entered into the student to generate the level of achieving the objectives. When the figures were entered for all the courses, the final result was calculated and the outcome was generated by highlighting the percentage achieved for each objective. At the end of the graph, the overall outcome percentage of all the objectives was also, achieved significantly.

The legend for each course displayed on the right hand side, while the scale of percentage is displayed on the left hand side. The calculation of the Learning Outcomes helps the faculty members to understand the achievement percentage of the objectives achieved by individual students for each course, and to make necessary changes in the curriculum materials and course requirements for future improvements when teaching the same courses again.

### Summary of Calculations/Formulas

The following represents a summary of the method for analyzing and deriving the learning outcomes of an educational course for an individual student or for a group of students.

The process for determining the Learning Outcomes is a mathematical process that utilizes information entered into a system for calculating a percentage of achievement for each Learning Outcome. This percentage of achievement for each Learning Outcome may be calculated for an individual student or a group of students, and the mathematical process is essentially the same for either. The same methodology is used for all course levels.

The process takes the total raw scores achieved by a student, weights that score and then combines weighted scores from all requirements associated with a particular Learning Objective to calculate a Learning Outcome Percentage. The Learning Outcome Percentage may be shown for an individual student, for a group of students, or summarized to reflect the achievement of a student or group of students for all Learning Objectives considered.

The method used to determine the Learning Outcome Percentage for any particular course of instruction is as follows:
1. An entry is made for each Learning Objective
2. The course Requirements are entered. (A course Requirement is a quiz, test, paper, project, mid-term, final or other measurable assignment completed by the students). Included in this entry for each Requirement is the following information
   a. The type of Requirement
   b. The number of questions/sections in the Requirement
   c. The number of raw points possible for each question/section of the Requirement
   d. The Total Raw Point possible for the Requirement with all questions/sections included (TRP)
   e. The percentage of the total grade attributable to the Requirement (GP)
3. Through user entry, each question/section of each Requirement is linked to a Learning Objective.
4. A mathematical calculation is done to determine the weighted value of all points for a given Requirement, or Total Weighted Point Value (TWPV). The formula for this weighting calculation is:

TRP×GP=TWPV
The TWPV is expressed as a number but is not reported. It is used internally.
5. The TWPV calculation follows by a calculation to determine Single Point Weighted Value (SPWV) for each point in a requirement. The formula is as follows:

TWPV/TRP=SPWV
The SPWV is expressed as a number, but is not reported. It is used internally.
6. A calculation is done to determine the total possible weighted point value for each question/section of a requirement (QWPV). This calculation simply multiplies the raw point value of each question (QRP) times the SPWV for the Requirement in which the question resides. The formula is as follows:

QRP×SPWV=QWPV
The QWPV is expressed as a number, but is not reported. It is used internally.
7. The raw score achieved by the student for each question/section of each Requirement, or Student Raw Score (SRS) is entered.
8. A mathematical calculation is done to determine the Weighted Point Value Achieved (WPVA) for each question/section of each Requirement. For each SRS on each question/section the following formula is applied to determine the WPVA.

SRS×SPWV=WPVA
The WPVA is expressed as a number, but is not reported. It is used internally.
9. All questions/sections from all Requirements linked with a particular Learning Objective are then grouped. Two totals are then calculated based on each student's numbers.
   a. The Sum of all QWPV's from all questions/sections of all Requirements linked with a particular Learning Objective (SuQWPV)
   b. The Sum of all WPVA's from all questions/sections of all Requirements linked with a particular Learning Objective (SuWPVA)
The SuQWPV and the SuWPVA are expressed as numbers. They are used internally.
10. As simple division calculation is then done to determine the Learning Outcome Percentage achieved by each individual student for each Learning Objective (ILOP). The formula is as follows:

SuWPVA/SuQWPV=ILOP (individual student)
The ILOP is expressed as a percentage and is reported.
11. A further series of calculations determines the Learning Outcome Percentage for a group of students (GLOP).
   a. The Sum of the ILOP for all students for a particular Learning Objective is calculated. (SuILOP)
   b. The SuILOP is then divided by the Number of Students (NOS) to determine the GLOP.
The formula is a follows:

SuILOP/NOS=GLOP (student group)
The GLOP is expressed as a percentage and is reported.
12. The process also calculates an over-all percentage of achievement for all Learning Objectives by a student (SOLOP). This is a simple average of the student's ILOP for all Learning Objectives.
   a. The sum of each individual ILOP's (individual student) from each different Learning Objective are added (SuISILOP), then divided by the Number of Learning Objectives (NLO) to achieve an Overall Learning Outcome Percentage (by Student) (SOLOP)

SuISILOP/NLO=SOLOP (by student)
The SOLOP is expressed as a percentage and is reported.
13. The process further calculates an over-all percentage of achievement by all students for all Learning Objectives by a group of students (GOLOP). This is a simple average of the student group's achievement for all Learning Objectives.
   a. The sum of all GLOP's (student group) from each different Learning Objective are added (SuGSGLOP), then divided by the NLO to achieve an Overall Learning Outcome Percentage by the Group (GOLOP)

SuGSGLOP/NLO=GOLOP (by group)
The GOLOP is expressed as a percentage and may be reported.
   The following are provided for reference.

| Term/Acronym | Description |
|---|---|
| Learning Outcome | A measure of student achievement for |
| Percentage | a Learning Objective |
| Requirement | A measurable testing of a student's |
| | achievement. A Requirement may be a |
| | quiz, test, paper, project, mid-term |
| | examination, final examination or |
| | other measurable assignment. |
| | A Requirement typically consists of |
| | multiple questions/sections each |
| | with its own raw point value. |
| TRP Total Raw Points. | The total raw points possible on a |
| | Requirement |
| GP Grade Percentage. | The percentage of the total grade |
| | attributable to a particular |
| | Requirement |
| TWPV Total Weighted | The value of all weighted points |
| Point Value. | for a particular Requirement |
| SPWV Single Point | The weighted value of a single point |
| Weighted Value. | on a particular Requirement |
| QRP Question Raw Points. | The raw point value of the total |
| | points possible on a single |
| | question/section of a Requirement |
| QWPV Question Weighted | The weighted point value of the |
| Point Value. | total points possible on a single |
| | question/section of a Requirement |
| SRS Student Raw Score. | The raw point score achieved by a |
| | student on a single question/section |
| | of a Requirement |
| WPVA Weighted Point | The weighted point score achieved by |
| Value Achieved. | a student on a single question/ |
| | section of a Requirement |
| SuQWPV Sum Question | The sum total of the weighted point |
| Weighted Point Value. | values for all questions/sections |
| | from all Requirements linked to a |
| | particular Learning Objective |
| SuWPVA Sum Weighted | The sum total of the weighted point |
| Point Value Achieved. | values achieved by a student for all |
| | questions/sections from all |
| | Requirements linked to a particular |
| | Learning Objective |
| ILOP Individual | A percentage representing the level |
| Learning Outcome | of achievement for a Learning |
| Percentage. | Objective for any given student |
| SuILOP Sum Individual | The sum total of the individual |
| Learning Objective | learning objective percentages from |
| Percentage. | a group of students |
| NOS Number Of Students. | The number of students in a group |
| | being evaluated. Typically a group |
| | of students represents the class |
| | roster for an individual course of |
| | study |
| GLOP Group Learning | A percentage representing the level |
| Outcome Percentage. | of achievement for a Learning |
| | Objective for a group of students |
| SuISILOP Sum Individual | The sum total of the individual |
| Student Individual | learning outcome percentages for |
| Learning Outcome | various Learning Objectives for |
| Percentage. | any given student |
| NLO Number Learning | The number of learning objectives |
| Objectives. | included in the SuISILOP |
| SOLOP Student Overall | The simple average of the individual |
| Learning Outcome | learning outcome percentages for the |
| Percentage. | various Learning Objectives for a |
| | particular student |
| SuGSGLOP Sum Group | The sum total of the group learning |
| Students Group | outcome percentage for the various |
| Learning Outcome | Learning Objectives for a group |
| Percentage. | |
| GOLOP Group Overall | The simple average of the group |
| Learning Outcome | learning outcome percentages for |
| Percentage. | the various Learning Objectives |
| | for a group of students |

While the invention has been described in connection with its preferred embodiment it should be recognized that changes and modifications may be made therein without departing from the scope of appended claims.

What is claimed is:

1. A method for analyzing and deriving the learning outcomes for a course of an individual student and/or for a group of students, said method comprising the steps of:
identifying a plurality of learning objectives for an individual course in education;
designing a plurality of course requirements for said individual course;
determining student achievements for a plurality of individual students;
combining the learning objectives, course requirements and student achievements to produce the learning outcomes for the plurality of individual students; and
extracting individual learning outcomes and finalizing overall learning outcomes to thereby access the effectiveness of said individual course.

2. A method for analyzing and deriving the learning outcomes for a course of an individual student and for a group of students according to claim 1 in which the analysis includes the step of comparing the results with the results from a prior course.

3. A method for analyzing and deriving the learning outcomes for a course of an individual student and for a group of students according to claim 1 in which the identification of learning objections are selected from specified activities that can be observed, measured and performed by learners.

4. A method for analyzing and deriving the learning outcomes for a course of an individual student and for a group of students according to claim 3 in which an instructor starts to identify learning objectives by identifying knowledge and skills that a student will gain by the end of the course.

5. A method for analyzing and deriving the learning outcomes for a course of an individual student and for a group of students according to claim 4 in which the characteristics of the learning objectives reflect broad conceptual knowledge and adapted vocational skills, essential knowledge that must be achieved to complete the course.

6. A method for analyzing and deriving the learning outcomes for a course of an individual student and for a group of students according to claim 3 in which said course requirements are measured by traditional assessments including examinations, quizzes, projects and assignments and grade point averages thereof.

7. A method for analyzing and deriving the learning outcomes for a course of an individual student and for a group of students according to claim 6 in which student achievement is an indication of gained knowledge and skills that are measured by different types of course requirements.

8. A method for analyzing and deriving the learning outcomes for a course of an individual student and for a group of students according to claim 7 in which students achievements are measured by the following formula:
SuWPVA/SuQWPV=ILOP (individual student)

9. A method for analyzing and deriving the learning outcomes for a course of an individual student and for a group of students according to claim 8 in which learning outcomes are final reports of summative evaluations that indicate what a student or group of students achieve as a result of a learning activity and experience from a program of study.

10. A method for analyzing and deriving the learning outcomes for a course of an individual student and for a group of students according to claim 9 in which said method highlights students' current performance and need for change.

11. A method for analyzing and deriving the learning outcomes for a course of an individual student and for a group of students according to claim 10 in which said method serves as guidelines for curriculum change.

12. A method for analyzing and deriving the learning outcomes for a course of an individual student and for a group of students according to claim 11 which includes the step of analyzing data related to learning outcomes to determine the quality of an instructional program.
